(19) United States
(12) Patent Application Publication
(10) Pub. No.: US 2019/0084538 A1
(43) Pub. Date: Mar. 21, 2019

(54) BRAKING SYSTEM WITH FUNCTION OF ANTI-SOMERSAULT

(71) Applicant: LIO HO MACHINE WORKS LTD., Taoyuan City (TW)

(72) Inventors: NUI WANG, Victoria (AU); YUNG-SEN HUANG, Taoyuan City (TW); KUEN-CHIH LAN, Taoyuan City (TW)

(21) Appl. No.: 15/814,555

(22) Filed: Nov. 16, 2017

(30) Foreign Application Priority Data
Sep. 15, 2017 (TW) 106131728

(51) Int. Cl. B60T 8/40; B60T 8/1755; B60T 8/172; B60T 8/32; B60T 8/17

(52) U.S. Cl. CPC B60T 8/4004; B60T 8/1755; B60T 8/1706; B60T 8/3225; B60T 8/172

(57) ABSTRACT

A braking system with function of anti-somersault, comprising: a hydraulic unit, a piston, a drive unit, a suspension travel sensor, and an ECU. During braking, according to a suspension travel signal generated by the suspension travel sensor, the ECU is able to determine whether a vehicle with short wheel base and high centre of gravity tends to be subject to forward somersault or not. Once confirmed, the ECU immediately sends a control signal to the drive unit, so as to drive the piston move towards a pressure releasing direction, such that fluid pressure on the downstream side of the hydraulic unit is blocked from changing. Moreover, further increase of the piston's displacement increases fluid volume in an oil chamber of the hydraulic unit so as to largely reduce the downstream fluid pressure. Consequently, braking force applied to the vehicle by the braking caliper decreases, and the forward somersault is prevented.

### BACKGROUND OF THE INVENTION

### 1. Field of the Invention

The present invention relates to the technology field of braking systems, and more particularly to a braking system with function of anti-somersault.

### 2. Description of the Prior Art

Two-wheel vehicles with short wheel base and high centre of gravity such as scooter, motorbike and motorcycle have become the primary transportation tools of modern people in city. Traditional two-wheel vehicle is commonly equipped with a brake system. However, when a hard braking is applied to the two-wheel vehicle by a vehicle biker through the brake system, the two-wheel vehicle may be subject to crash due to loss of wheel friction and/or somersaulting.

Accordingly, commercial two-wheel vehicles are now equipped with an anti-braking system (ABS). FIG. 1 shows a schematic framework view of the anti-braking system. From FIG. 1, it is understood that conventional anti-braking system 1′ mainly comprises: a brake lever 11′, a hydraulic unit 12′, a brake caliper 13′, a brake disc 14′, a wheel speed sensor 15′, an electronic control unit (ECU) 16′, a solenoid driver 17′, and a shaft coupling 18′. There is a piston travel channel 121′ formed in the hydraulic unit 12′, and a piston 19′ is disposed in the piston travel channel 121′. Moreover, the hydraulic unit 12′ further comprises an oil inlet 122′ and an oil outlet 123′ laterally connected to the piston travel channel 121′. It is worth noting that, a bypass channel 124′ is connected between the oil outlet 123′ and the piston travel channel 121′.

Please simultaneously refer to FIG. 2, which also shows a schematic framework view of the anti-braking system. After the vehicle biker presses the brake lever 11′, braking fluid flows into a connect channel 125′ of the piston 19′ through the oil inlet 122′, and subsequently flows from the oil outlet 123′ to the brake caliper 13′. As a result, braking force applied on the brake disc 14′ installed on the wheel of the two-wheel vehicle 2′is enhanced with the increase of the fluid pressure in the brake caliper 13′. In the meantime, the wheel speed sensor 15′ would monitor the speed variation of the wheel of the vehicle 2′ and then send an wheel speed signal to the ECU 16′.

As FIG. 2 shows, when the wheel 2′ tends to be tightly locked by the brake caliper 13′, the motor driver 17′ is immediately informed by ECU' so as to control the piston 19′ make an upward move through the driving of the shaft coupling 18′. Therefore, by upwardly moving the connect channel 125′ of the piston 19′, oil inlet 122′ and oil outlet 123′ fail to communicate with the connect channel 125′, such that the fluid pressure on the downstream side of the hydraulic unit 12′ is hence blocked from continuously increasing. As a result, brake caliper 13′ is controlled to reduce braking force applied on the brake disc 14′ due to the fact that the downstream fluid pressure is decreased. However, it is worth noting that, the downstream fluid pressure of the hydraulic unit 12′ would be increased again once the wheel speed rises again. Eventually, by carrying out cycles of increasing and reducing braking force, the anti-braking system 1′ successfully prevent the two-wheel vehicle from being subject to crash due to, hard braking, loss of wheel friction and/or somersaulting.

Even though the commercial two-wheel vehicles are now equipped with the anti-braking system 1′, the two-wheel vehicles does still not have a comprehensive protect from crash. From a side view of the two-wheel vehicle provided by FIG. 3, it is able to know that, the two-wheel vehicle would be subject to forward somersault (or topple) once (M\ddot{X}×h) is greater than (Mg×d) during braking of the two-wheel vehicle. In FIG. 1, CG and Mg means a center gravity and a system weight of the vehicle biker, respectively. Moreover, BF_{f} and M\ddot{X} are respectively a road friction force and a forward inertia force. On the other hand, “h” means a height between CG and ground, and “d” represents a distance between CG and front wheel of the two-wheel vehicle.

Briefly speaking, the conventional anti-braking system 1′ cannot protect the two-wheel vehicle from being subject to forward somersault (or topple) in the case of sudden braking. In view of that, inventors of the present application have made great efforts to make inventive research thereon and eventually provided a braking system with function of anti-somersault.

### SUMMARY OF THE INVENTION

The primary objective of the present invention is to provide a braking system with function of anti-somersault, which mainly comprises: a hydraulic unit, a piston, a drive unit, a (rear-wheel) suspension travel sensor, and an electronic control unit (ECU). During braking, according to a suspension travel signal generated by the suspension travel sensor, the ECU is able to determine whether a vehicle with short wheel base and high centre of gravity tends to be subject to forward somersault or not. Once confirmed, the ECU immediately sends a control signal to the drive unit, so as to drive the piston move towards a pressure releasing direction, such that fluid pressure on the downstream side of the hydraulic unit is blocked from changing. Moreover, further increase of the piston's displacement increases fluid volume in an oil chamber of the hydraulic unit so as to largely reduce the downstream fluid pressure. Consequently, braking force applied to the vehicle by the braking caliper decreases, and the forward somersault is prevented.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a schematic framework view of a conventional anti-braking system;

FIG. 2 shows a schematic framework view of the anti-braking system;

FIG. 3 shows a side view of a two-wheel vehicle;

FIG. 4 shows a stereo diagram of a motorbike;

FIG. 5A, FIG. 5B, FIG. 5C, and FIG. 5D show schematic framework views of a first embodiment of a braking system with function of anti-somersault according to the present invention;

FIG. 6 and FIG. 7 show stereo diagrams of a suspension travel sensor;

FIG. 8A, FIG. 8B and FIG. 8C show schematic framework views of a second embodiment of the braking system with function of anti-somersault;

FIG. 9A, FIG. 9B and FIG. 9C show schematic framework views of a third embodiment of the braking system with function of anti-somersault;

FIG. 10A, FIG. 10B, FIG. 10C, FIG. 10D, and FIG. 10E show schematic framework views of a fourth embodiment of the braking system with function of anti-somersault; and

FIG. 11 shows a schematic framework view of a fifth embodiment of the braking system with function of anti-somersault.

### DETAILED DESCRIPTION OF THE PREFERRED EMBODIMENTS

To more clearly describe a braking system with function of anti-somersault according to the present invention, embodiments of the present invention will be described in detail with reference to the attached drawings hereinafter.

### First Embodiment

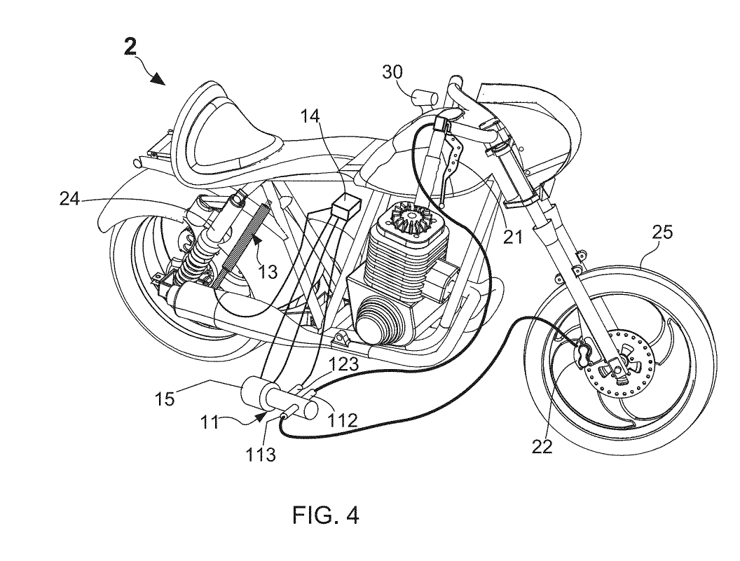

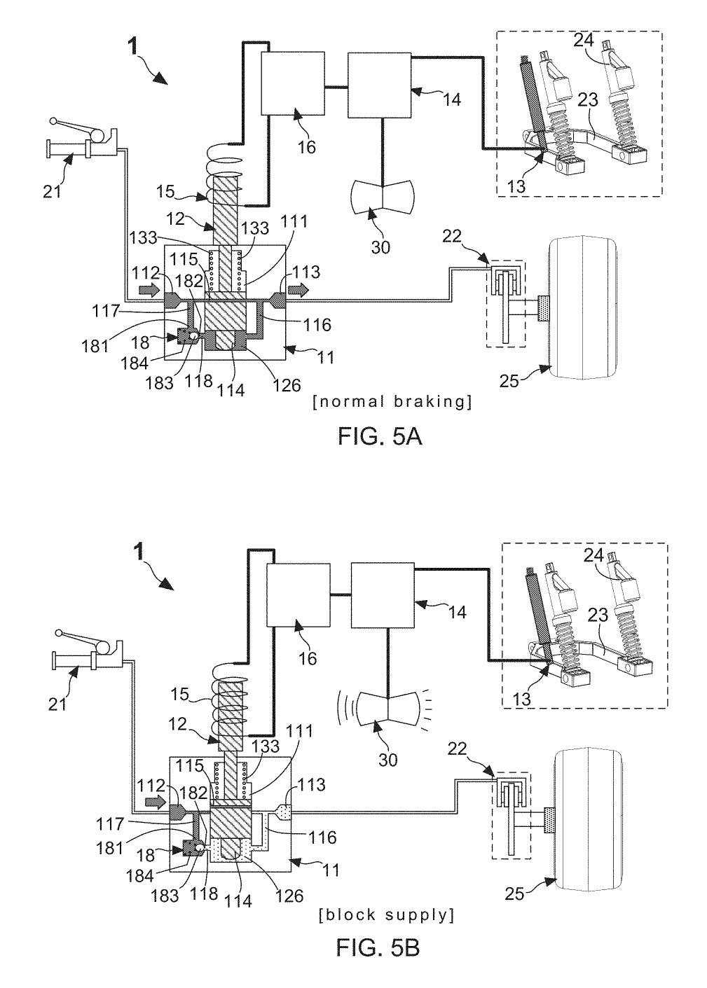

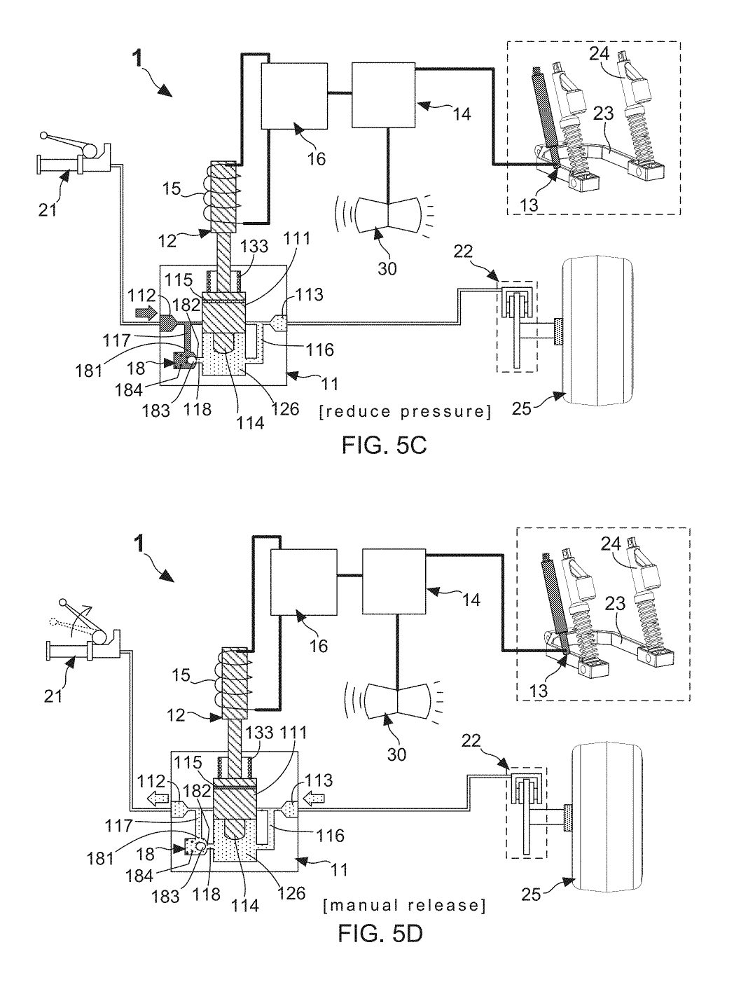

With reference to FIG. 4, there is provided a stereo diagram of a motorbike. Moreover, FIG. 5A, FIG. 5B, FIG. 5C, and FIG. 5D show schematic framework views of a first embodiment of a braking system with function of anti-somersault according to the present invention. Particularly, this braking system 1 is applied in a vehicle 2 with short wheel base and high centre of gravity, such as scooter, motorbike or motorcycle. From FIG. 4, it is understood that the braking system 1 of the present invention comprises: a hydraulic unit 11, a drive unit comprising a connect rod 12 and a coil 15, a (rear-wheel) suspension travel sensor 13, an alarm unit 30, and an electronic control unit (ECU) 14, wherein the hydraulic unit 11 comprises a piston travel channel 111, an oil inlet 112 and an oil outlet 113. Moreover, a piston 114 having a connect channel 115 is disposed in the piston travel channel 111, and the oil inlet 112 and the oil outlet 113 are connected to a brake lever 21 and a brake caliper 22 of the vehicle 2. It is worth noting that, before the piston is driven to move, the connect channel 115 communicates with the oil inlet 112 and the oil outlet 113. In addition, the hydraulic unit 11 further comprises a first bypass channel 116, a second bypass channel 117 and a third bypass channel 118, wherein the first bypass channel 116 is connected between an oil chamber 126 in the piston travel channel 111 and the oil outlet 113. Moreover, the second bypass channel 117 and the third bypass channel 118 are respectively connected to the oil inlet 112 and the oil chamber 126 by one end.

As FIG. 5A shows, the hydraulic unit 11 further comprises a non-return ball valve 18, which is connected to the other end of the second bypass channel 117 and the other end of the third bypass channel 118 by a first gate 181 and a second gate 182 thereof. It is worth explaining that, a ball 183 and a spring 184 connected to the ball 183 are disposed in the non-return ball valve 18. Moreover, engineers skilled design and manufacture of the non-return ball valve 18 should know that, the non-return ball valve 18 is adopted for allowing braking fluid in the oil chamber 126 to flow out of the oil inlet 112 via the third bypass channel 118 as long as the fluid pressure at the second gate 182 is greater than the fluid pressure at the first gate 181.

The drive unit is used for controlling the piston 114 to finish a piston travel (i.e. an upward travel) based on a control signal generated by the ECU 14. As FIG. 5A shows, the connect rod 12 of the drive unit is connected to the piston 114, and the coil 15 is wound on the connect rod 12 and simultaneously electrically connected to the ECU 14. On the other hand, the suspension travel sensor 13 is adjacent to a (rear-wheel) suspension mechanism 24 of the vehicle 2. In the present invention, the suspension travel sensor 13 is used for monitoring a suspension displacement of the suspension mechanism 24, and then outputs a suspension travel signal to the ECU 14.

Please refer to FIG. 4 and FIG. 5A-FIG. 5D again. In the present invention, after receiving the suspension travel signal, the ECU 14 is able to determine whether the vehicle 2 tends to be subject to forward somersault or not. As FIG. 5A shows, during the brake system 1 is operated at a normal braking state, the bottom end of the piston 14 touches the bottom of the oil chamber 126 because the top end of the piston 14 is pushed by the spring 133. It is worth noting that, as FIG. 5B shows, the alarm unit 30 is controlled by the ECU 14 to show alarm information to the vehicle biker during the vehicle 2 tending to be subject to forward somersault. In the meantime, ECU 14 makes a current generating unit 16 to supply a current to the coil 15, and the coil subsequently produces a magnetic field to drive the connect rod 12 and the piston 114 move upwardly. Herein, it needs to further explain that the alarm unit 30 can be a light indicating device, a sound broadcasting device, a vibration device, an image displaying device, or a combination of aforesaid two or more devices.

FIG. 5B describes that brake system 1 is operated at a block supply state. As FIG. 5B shows, communication between the connect channel 115 and the oil inlet 112 as well as the oil outlet 113 is broken as the piston 114 executes a piston travel (i.e., the upward move). Meanwhile, the fluid pressure in the (front-wheel) brake caliper 22 is blocked from rising even if the apply force on the brake lever provided by the vehicle biker is continuously increased. Consequently, braking force applied to the vehicle 2 by the braking caliper 22 is blocked from being enhanced, and the forward somersault of the vehicle 2 is hence prevented.

FIG. 5C depicts that the brake system is operated at a reduce pressure state. As FIG. 5C shows, a fluid volume of the oil chamber 126 is enlarged with the execution of the piston travel, and the enlarging of the fluid volume making the fluid pressure on the downstream side (i.e., the oil chamber 126 and the oil outlet 113) of the hydraulic unit 11 be reduced, such that the braking force applied to a front wheel 25 of the vehicle 2 by the braking caliper 22 decreases, and the forward somersault of the vehicle 2 is prevented. It needs to particularly explain that, the (rear-wheel) suspension mechanism 24 would decline after the braking force of the front wheel 25 decreases. In the meantime, the suspension travel sensor 13 still continuously monitors the suspension displacement of the suspension mechanism 24 until the ECU 14 judge the vehicle 2 quits from the state of tending to be subject to forward somersault.

After the vehicle 2 quits from the state of tending to be subject to forward somersault, the piston 114 is control to move back to its original position for restoring the communication between the connect channel 115 and the oil inlet 112 as well as the oil outlet 113. Of course, when the vehicle biker receives the alarm information from the alarm unit 30 and then knows the fact that the vehicle 2 tends to be subject to forward somersault during the execution of the piston travel, the vehicle biker can fully or partially release the brake lever 21 to reduce the fluid pressure on the upstream side of the hydraulic unit 11. FIG. 5D describes that the brake system 1 is operated at a manual release state. As FIG. 5D shows, fluid pressure at the oil inlet 112 declines with the release level of the brake lever 21. Moreover, when the fluid pressure at the second gate 182 is greater than the fluid pressure at the first gate 181, the non-return ball valve 18 allows the braking fluid in the oil chamber 126 to flow out of the oil inlet 112 via the third bypass channel 118. As a result, the braking force applied to the front wheel 25 of the vehicle 2 by the braking caliper 22 decreases, and the forward somersault of the vehicle 2 is hence prevented. Further descriptions for each operation states of the brake system shown by FIG. 5A-FIG. 5D are provided in following Table (1).

TABLE (1)

| | | Position of the | |
|---|---|---|---|
| | Corre- | piston 114 in the | |
| | sponding | piston travel | |
| Operation states | figures | channel 111 | Fluid pressure |
| Normal braking state | FIG. 5A | Low | High |
| Block supply state | FIG. 5B | From low | From high to high |
| | | to lower | |
| Reduce pressure state | FIG. 5C | High | From high to low |
| Manual release state | FIG. 5D | High | From low to the |
| | | | lowest or zero |

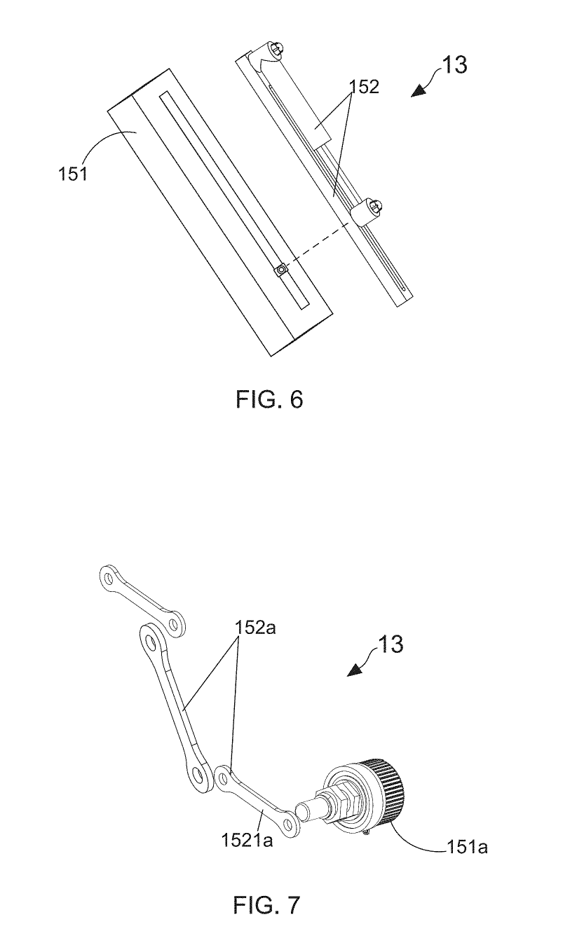

Please refer to FIG. 6 and FIG. 7, which illustrate different stereo diagrams of the suspension travel sensor. FIG. 6 depicts that the suspension travel sensor 13 comprises a sliding rheostat 151 and an adjust unit 152, wherein the adjust unit 152 is a slider mechanism connected between the swing arm 23 and a motorbike frame. In the present invention, the adjust unit is configured to adjust the resistance of the sliding rheostat 151 according to the suspension displacement completed by the (rear-wheel) suspension mechanism 24. Therefore, after receiving a resistance variation signal (i.e. the suspension travel signal), the ECU 14 is able to determine whether the vehicle 2 tends to be subject to forward somersault or not. Herein it needs to further explain that, the adjust unit 152 can also be a linage mechanism, a drag link mechanism or a push rod mechanism. For instance, FIG. 7 depicts that that the suspension travel sensor 13 can also constituted by a rotary rheostat 151a and a linage mechanism 152a.

### Second Embodiment

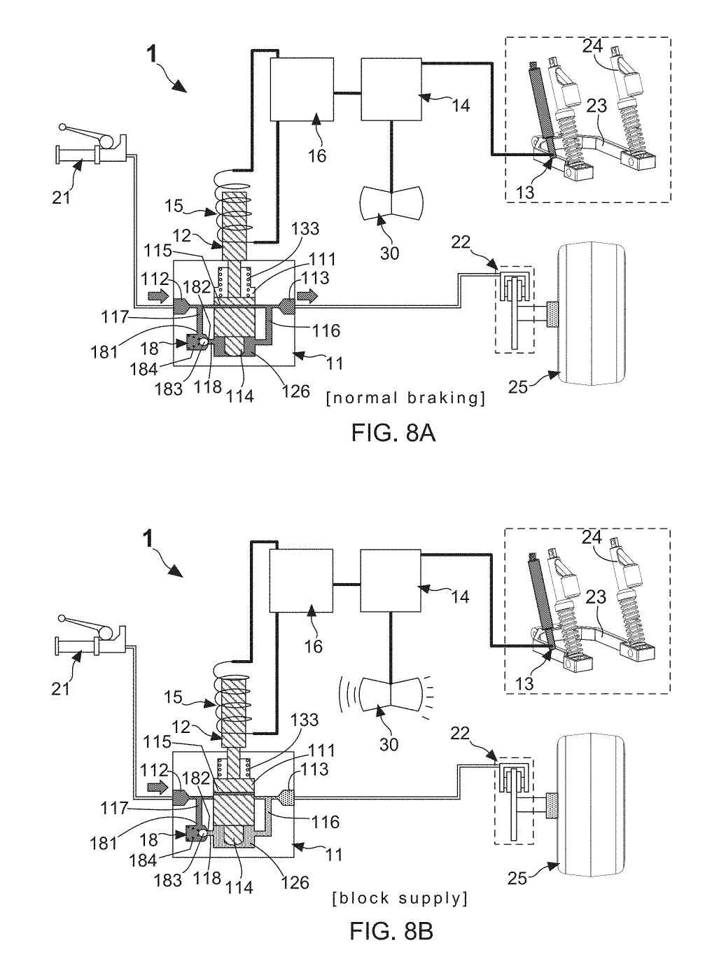

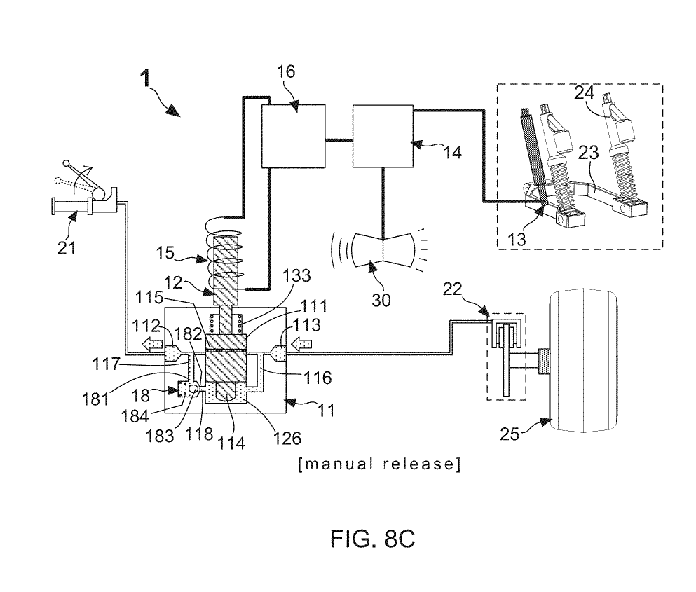

With reference to FIG. 8A, FIG. 8B and FIG. 8C, there are provided schematic framework views of a second embodiment of the braking system with function of anti-somersault according to the present invention. After comparing FIG. 5A with FIG. 8A, it is understood that the second embodiment of the braking system 1 also comprises: a hydraulic unit 11, a drive unit comprising a connect rod 12 and a coil 15, a (rear-wheel) suspension travel sensor 13, an alarm unit 30, and an electronic control unit (ECU) 14. As FIG. 8A shows, during the brake system 1 is operated at a normal braking state, the bottom end of the piston 14 touches the bottom of the oil chamber 126 because the top end of the piston 14 is pushed by the spring 133. However, as FIG. 8B shows, the alarm unit 30 is controlled by the ECU 14 to show alarm information to vehicle biker during the vehicle 2 tending to be subject to forward somersault. In the meantime, ECU 14 makes a current generating unit 16 to supply a current to the coil 15, and the coil subsequently produces a magnetic field to drive the connect rod 12 and the piston 114 move upwardly. FIG. 8B describes that brake system 1 is operated at a block supply state, in which communication between the connect channel 115 and the oil inlet 112 as well as the oil outlet 113 is broken as the piston 114 executes a piston travel (i.e., the upward move). Meanwhile, the fluid pressure in the (front-wheel) brake caliper 22 is blocked from rising even if the apply force on the brake lever provided by the vehicle biker is continuously increased. Consequently, braking force applied to the vehicle 2 by the braking caliper 22 is blocked from being enhanced, and the forward somersault of the vehicle 2 is hence prevented.

In the second embodiment, the vehicle biker may also receive the alarm information from the alarm unit 30 so as to know the fact that the vehicle 2 tends to be subject to forward somersault during the execution of the piston travel; meanwhile, the vehicle biker can fully or partially release the brake lever 21 to reduce the fluid pressure on the upstream side (i.e. the oil chamber 126 and the oil outlet 113) of the hydraulic unit 11. FIG. 8C describes that the brake system 1 is operated at a manual release state. As FIG. 8C shows, fluid pressure at the oil inlet 112 declines with the release level of the brake lever 21. In the meantime, when the fluid pressure at the second gate 182 is greater than the fluid pressure at the first gate 181, the non-return ball valve 18 allows the braking fluid in the oil chamber 126 to flow out of the oil inlet 112 via the third bypass channel 118. As a result, the braking force applied to the front wheel 25 of the vehicle 2 by the braking caliper 22 decreases, and the forward somersault of the vehicle 2 is hence prevented.

Moreover, After the vehicle 2 quits from the state of tending to be subject to forward somersault, the piston 114 is control to move back to its original position for restoring the communication between the connect channel 115 and the oil inlet 112 as well as the oil outlet 113. It is worth explaining that, since the piston travel completed by the piston 114 shown in FIG. 5A-FIG. 5D is greater than the piston travel finished by the piston 114 shown in FIG. 8A-FIG. 8C, that means the second embodiment's framework facilitates the brake system 1 spend lower power to finish the piston travel. Therefore, it is clear that the brake system 1 based on the second embodiment's framework is a low cost brake system, and suitable for being applied in a specific vehicle 2 with the properties of short wheel base, high centre of gravity and rigid front-wheel suspension.

### Third Embodiment

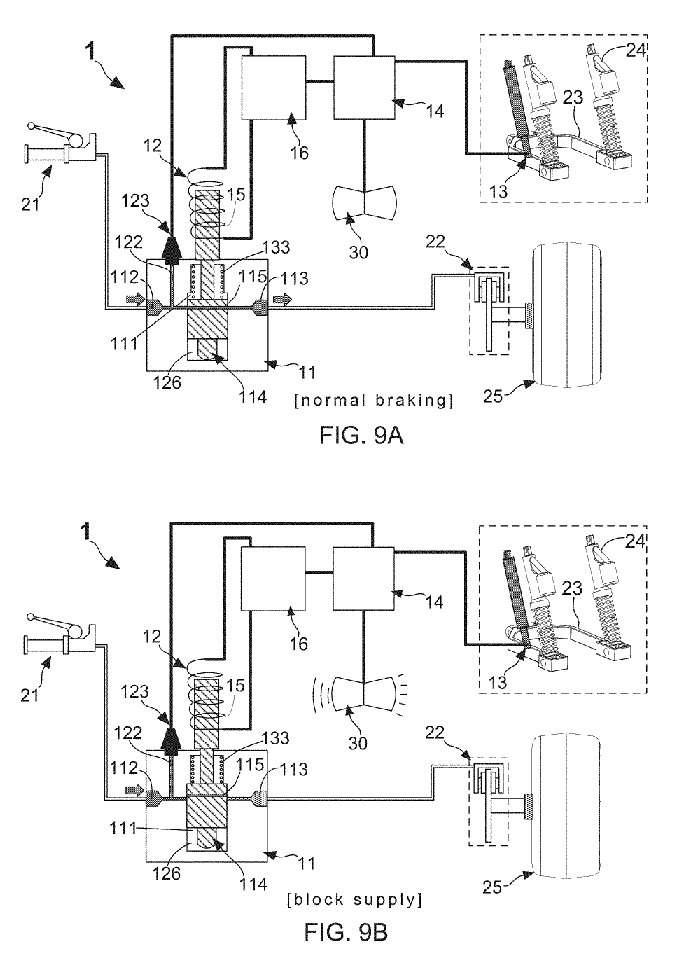

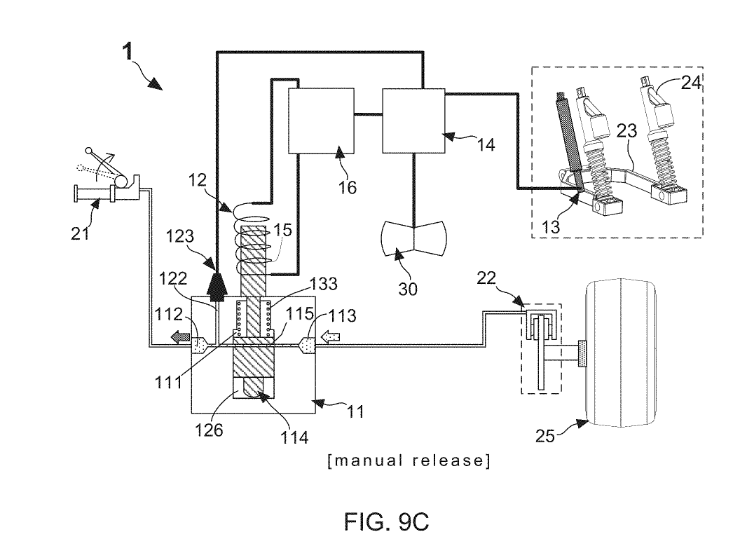

FIG. 9A, FIG. 9B and FIG. 9C further show schematic framework views of a third embodiment of the braking system. After comparing FIG. 5A with FIG. 9A, it is understood that the non-return ball valve is removed from the hydraulic unit 11. Particularly, in the third embodiment's framework, a fluid pressure sensing channel 122 is formed in the hydraulic unit 11 for communicating with the oil inlet 112 by one end thereof. Moreover, a fluid pressure sensor 123 is connected to the other end of the fluid pressure sensing channel 122, and used for monitoring the fluid pressure at the oil inlet 112. As FIG. 9A shows, during the brake system 1 is operated at a normal braking state, the bottom end of the piston 14 touches the bottom of the oil chamber 126 because the top end of the piston 14 is pushed by the spring 133. However, as FIG. 9B shows, the alarm unit 30 is controlled by the ECU 14 to show alarm information to vehicle biker during the vehicle 2 tending to be subject to forward somersault. In the meantime, ECU 14 makes a current generating unit 16 to supply a current to the coil 15, and the coil subsequently produces a magnetic field to drive the connect rod 12 and the piston 114 move upwardly. FIG. 9B describes that brake system 1 is operated at a block supply state, in which communication between the connect channel 115 and the oil inlet 112 as well as the oil outlet 113 is broken as the piston 114 executes a piston travel (i.e., the upward move). Meanwhile, the fluid pressure in the (front-wheel) brake caliper 22 is blocked from rising even if the apply force on the brake lever provided by the vehicle biker is continuously increased. Consequently, braking force applied to the vehicle 2 by the braking caliper 22 is blocked from being enhanced, and the forward somersault of the vehicle 2 is hence prevented.

In the third embodiment, the vehicle biker may also receive the alarm information from the alarm unit 30 so as to know the fact that the vehicle 2 tends to be subject to forward somersault during the execution of the piston travel; meanwhile, the vehicle biker can fully or partially release the brake lever 21 to reduce the fluid pressure on the upstream side (i.e. the oil chamber 126 and the oil outlet 113) of the hydraulic unit 11. FIG. 9C describes that the brake system 1 is operated at a manual release state. As FIG. 9C shows, when the fluid pressure at the oil inlet 112 declines and reaches a designate pressure (0 or approximate 0), the fluid pressure sensor 123 outputs a fluid pressure signal to the ECU 114, such that the ECU 114 controls the piston 114 to move back to its original position for restoring the communication between the connect channel 115 and the oil inlet 112 as well as the oil outlet 113. By comparing FIG. 5A with FIG. 9A, it is understood that the piston travel completed by the piston 114 of the first embodiment's framework is greater than the piston travel finished by the piston 114 of the third embodiment's framework. That means the third embodiment's framework facilitates the brake system 1 spend lower power to finish the piston travel. Therefore, it is clear that the brake system 1 based on the third embodiment's framework is a low cost brake system, and suitable for being applied in a specific vehicle 2 with short wheel base and high centre of gravity, wherein the centre of gravity of the vehicle 2 declines during vehicle braking.

### Fourth Embodiment

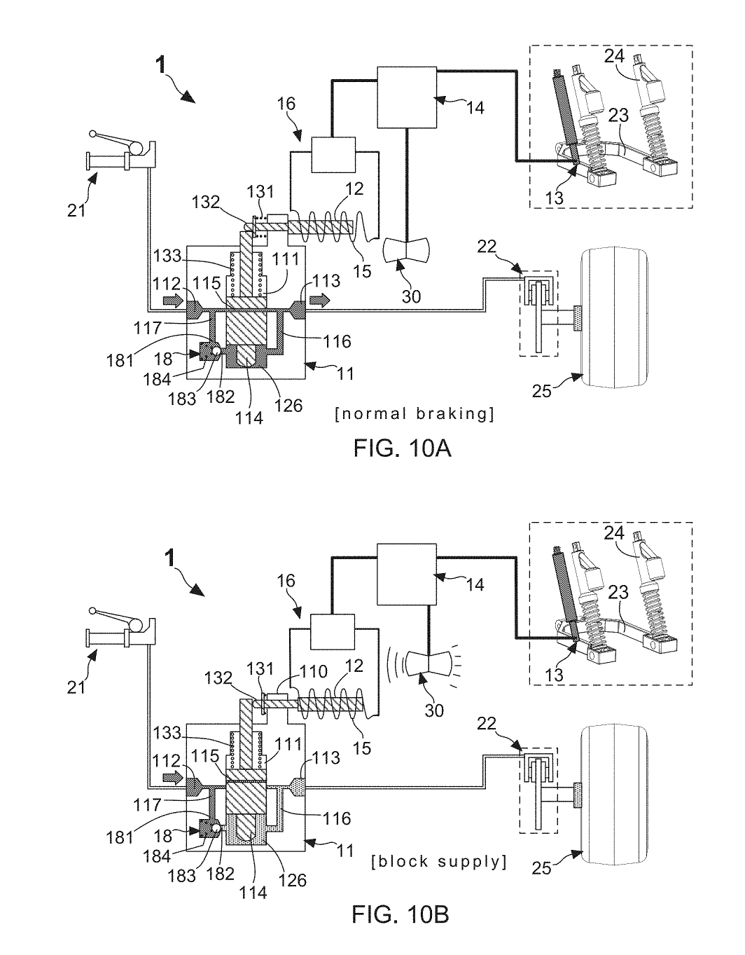

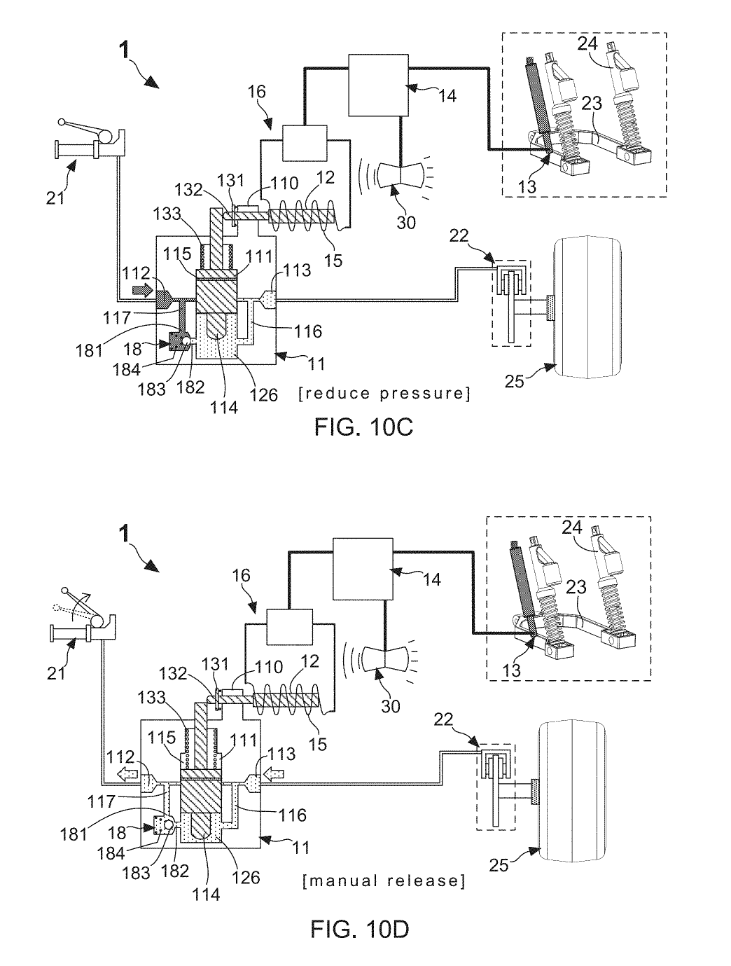

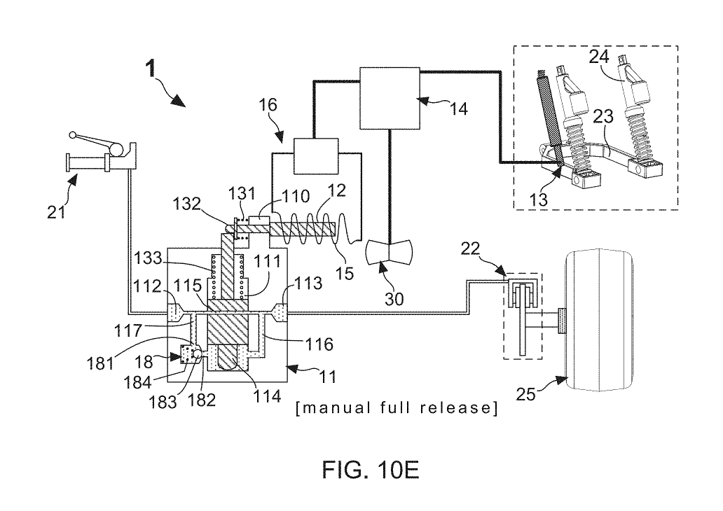

FIG. 10A-FIG. 10E further show schematic framework views of a fourth embodiment of the braking system. After comparing FIG. 5A with FIG. 10A, it is understood that the fourth embodiment's framework further comprises a stop pin 132 and a return spring 131. As FIG. 10A shows, the stop pin 132 is connected to the connect rod 12 for applying a motion limitation to the piston 114, and a spring fixing member is formed on the front end of the stop pin 132 for connecting with one end of the return spring 131. Moreover, a pin equipment portion is formed on the top of the hydraulic unit 11 for setting the stop pin 132, and the other end of the return spring 131 is connected to the pin equipment portion. As FIG. 10B shows, when the vehicle 2 tends to be subject to forward somersault, ECU 14 makes the current generating unit 16 to supply a current to the coil 15 for producing a magnetic field. Subsequently, the motion limitation on the piston 114 is released because the stop pin 132 moves with the connect rod 12 driven by the magnetic field of the coil 15. In the meantime, the piston 114 move upwardly since the pushing force of the spring 133 is smaller than the fluid pressure at the oil chamber 126. FIG. 10B describes that brake system 1 is operated at a block supply state, in which communication between the connect channel 115 and the oil inlet 112 as well as the oil outlet 113 is broken as the piston 114 executes a piston travel (i.e., the upward move). At this state, the fluid pressure in the (front-wheel) brake caliper 22 is blocked from rising even if the apply force on the brake lever provided by the vehicle biker is continuously increased. Consequently, braking force applied to the vehicle 2 by the braking caliper 22 is blocked from being enhanced, and the forward somersault of the vehicle 2 is hence prevented.

As FIG. 10C shows, fluid volume of the oil chamber 126 is enlarged with the execution of the piston travel, and the enlarging of the fluid volume making the fluid pressure on the downstream side (i.e., the oil chamber 126 and the oil outlet 113) of the hydraulic unit 11 be reduced. FIG. 10D describes that the brake system 1 is operated at a manual release state. As FIG. 10D shows, fluid pressure at the oil inlet 112 declines with the release level of the brake lever 21. Moreover, when the fluid pressure at the second gate 182 is greater than the fluid pressure at the first gate 181, the non-return ball valve 18 allows the braking fluid in the oil chamber 126 to flow out of the oil inlet 112 via the third bypass channel 118. As a result, the braking force applied to the front wheel 25 of the vehicle 2 by the braking caliper 22 decreases, and the forward somersault of the vehicle 2 is hence prevented. However, as FIG. 10E shows, when the fluid pressure at the oil chamber 126 is continuously reduced and then smaller than the pushing force of the spring 133, the piston 114 would be push back to its original position by the spring 133. After that, the stop pin 132 would be pushed back to its original position by the return spring 131 so as to provide the same motion limitation to the piston 114. In the meantime, the connect channel 115 communicates with the oil inlet 112 and the oil outlet 113 again.

FIG. 10A-FIG. 10 indicate the fourth embodiment's framework facilitates the brake system 1 spend lower power to finish the piston travel. Therefore, it is clear that the brake system 1 based on the fourth embodiment's framework is a low cost brake system, and suitable for being applied in a specific vehicle 2 with short wheel base and high centre of gravity, wherein the centre of gravity of the vehicle 2 declines during vehicle braking.

### Fifth Embodiment

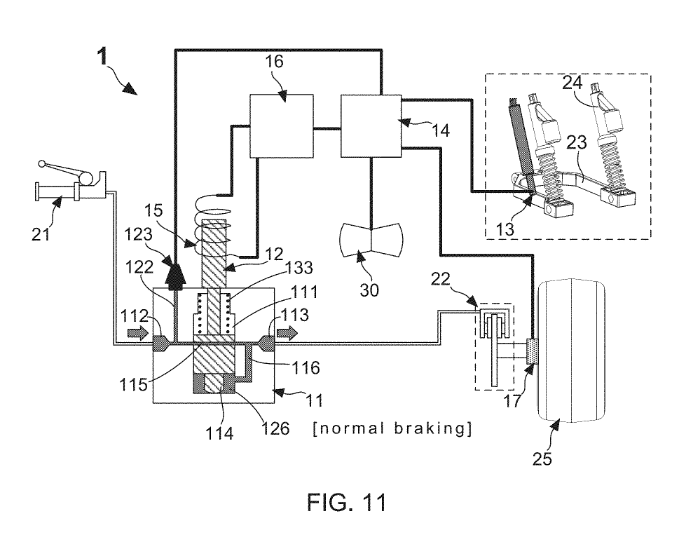

FIG. 11 further shows a schematic framework view of a fifth embodiment of the braking system. After comparing FIG. 9A with FIG. 11, it is understood that the fifth embodiment's framework further comprises a wheel speed sensor 17. After the vehicle biker presses the brake lever 21, braking fluid flows into the connect channel 115 of the piston 114 through the oil inlet 112, and subsequently flows from the oil outlet 113 to the brake caliper 22. As a result, braking force applied on the brake disc installed on the wheel 25 of the two-wheel vehicle 2 is enhanced with the increase of the fluid pressure in the brake caliper 22. In the meantime, the wheel speed sensor 17 would monitor the speed variation of the wheel of the vehicle 2 and then send an wheel speed signal to the ECU 14, therefore the ECU 14 immediately makes the piston 114 to move upwardly for reducing the fluid pressure in the brake caliper 22. At this state, the fluid pressure in the (front-wheel) brake caliper 22 is blocked from rising even if the apply force on the brake lever provided by the vehicle biker is continuously increased. Consequently, braking force applied to the vehicle 2 by the braking caliper 22 is blocked from being enhanced, and the forward somersault of the vehicle 2 is hence prevented.

Therefore, through above descriptions, the braking system with function of anti-somersault of the present invention have been introduced completely and clearly; in summary, the present invention includes the advantages of:

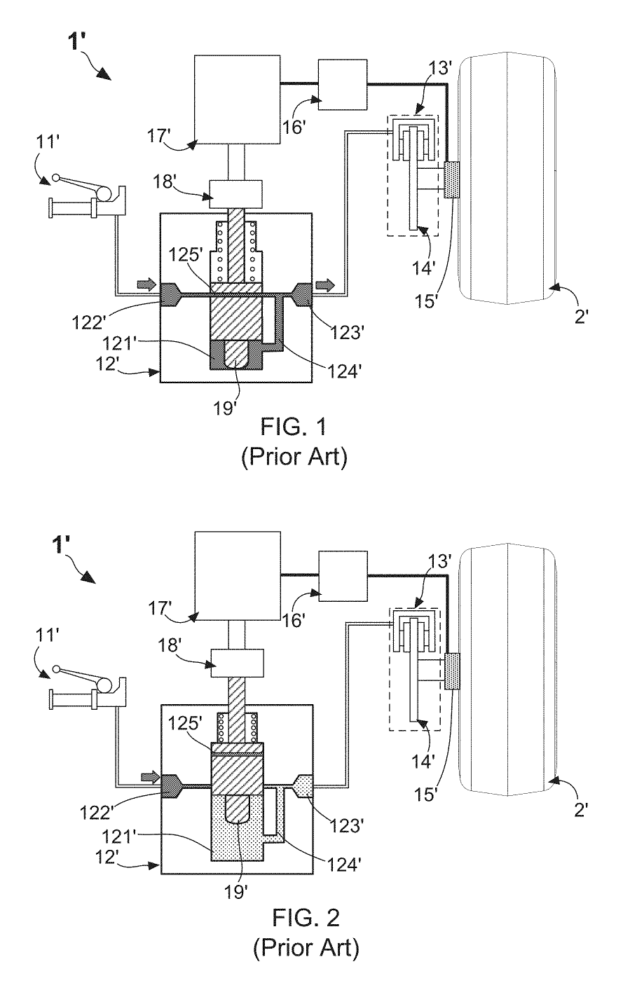

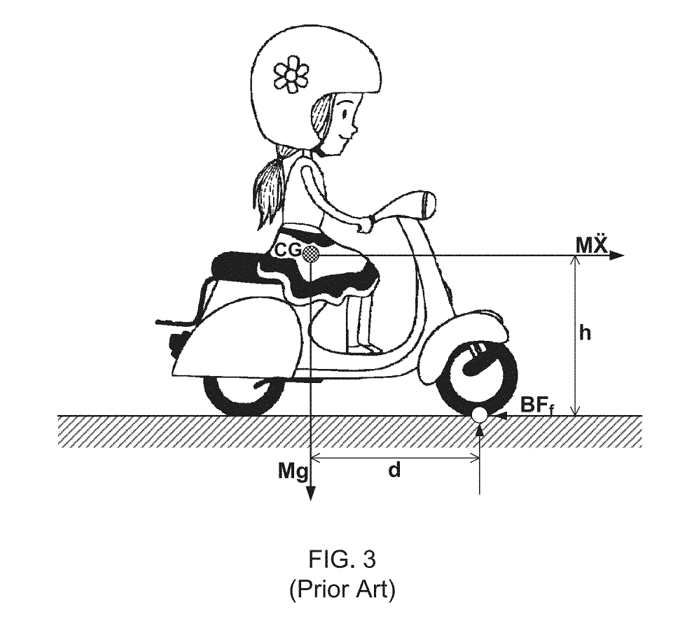

(1) The conventional anti-braking system (as FIG. 1 shows) cannot protect the two-wheel vehicle from being subject to forward somersault (or topple) in the case of sudden braking; in view of the that, the present invention particularly discloses a braking system 1 with function of anti-somersault, which mainly comprises: a hydraulic unit 11, a piston 114, a drive unit, a (rear-wheel) suspension travel sensor 13, and an electronic control unit (ECU) 14. During braking, according to a suspension travel signal generated by the suspension travel sensor 13, the ECU 14 is able to determine whether a vehicle 2 with short wheel base and high centre of gravity tends to be subject to forward somersault or not. Once confirmed, the ECU 14 immediately sends a control signal to the drive unit, so as to drive the piston 114 move towards a pressure releasing direction, such that fluid pressure on the downstream side of the hydraulic unit 11 is blocked from changing. Moreover, further increase of the piston's displacement increases fluid volume in an oil chamber 126 of the hydraulic unit 11 so as to largely reduce the downstream fluid pressure. Consequently, braking force applied to the vehicle 2 by the braking caliper 22 decreases, and the forward somersault is prevented.

The above description is made on embodiments of the present invention. However, the embodiments are not intended to limit scope of the present invention, and all equivalent implementations or alterations within the spirit of the present invention still fall within the scope of the present invention.

What is claimed is:

1. A braking system with function of anti-somersault for use in a vehicle with short wheel base and high centre of gravity, comprising:
a hydraulic unit, being connected between a brake lever and a brake caliper of the vehicle;
a piston in the hydraulic unit;
a drive unit connected to the piston; and
a suspension travel sensor for monitoring a suspension displacement of a suspension mechanism of the vehicle;
wherein the drive unit is configured to control the piston to make a piston travel in the hydraulic unit according to a suspension travel signal outputted from the suspension travel sensor, so as to block a fluid pressure in the brake caliper from continuously increasing with an apply force on the brake lever, such that forward somersault of the vehicle is prevented.

2. The braking system of claim 1, further comprising:
an electronic control unit (ECU), being electrically connected to the suspension travel sensor and the driver unit, and used for receiving the suspension travel signal and then determining whether the vehicle tends to be subject to forward somersault or not; and
an alarm unit, being electrically connected to the ECU, and configured to output alarm information during the vehicle tending to be subject to forward somersault.

3. The braking system of claim 2, wherein the hydraulic unit comprises:
an oil inlet connected to the brake lever;
an oil outlet connected to the brake caliper; and
a piston travel channel for accommodating the piston and connecting between the oil inlet and the oil outlet.

4. The braking system of claim 3, wherein the piston has a connect channel for communicating with the oil inlet and the oil outlet; moreover, communication between the connect channel and the oil inlet as well as the oil outlet is broken as the piston executes the piston travel.

5. The braking system of claim 3, wherein the hydraulic unit further comprises:
a first bypass channel, being connected between an oil chamber in the piston travel channel and the oil outlet;
a second bypass channel, being connected to the oil inlet by one end thereof;
a third bypass channel, being connected to the oil chamber by one end thereof; and
a non-return ball valve connected to the other end of the second bypass channel and the other end of the third bypass channel by a first gate and a second gate thereof.

6. The braking system of claim 3, wherein the drive unit comprises:
a connect rod for connecting a portion of the piston extending out of the hydraulic unit; and
a coil, being wound on the connect rod and electrically connected to the ECU;
wherein the coil produces a magnetic field after receiving a current supplied from the ECU, and the connect rod is driven by the magnetic field so as to control the piston to finish the piston travel in the hydraulic unit.

7. The braking system of claim 4, wherein the communication between the connect channel of the piston and the oil inlet as well as the oil outlet is broken at an initial stage of the piston travel, therefore the fluid pressure in the brake caliper is blocked from rising even if the apply force on the brake lever is continuously increased.

8. The braking system of claim 4, wherein a fluid volume of the oil chamber is enlarged with the execution of the piston travel, and the enlarging of the fluid volume making the fluid pressure on the downstream side of the hydraulic unit be reduced, such that a braking force applied to a front wheel of the vehicle by the braking caliper decreases, and the forward somersault of the vehicle is prevented.

9. The braking system of claim 4, wherein a biker of the vehicle is able to receive the alarm information from the alarm unit and then knows the fact that the vehicle tends to be subject to forward somersault during the execution of the piston travel; therefore, the biker can fully or partially release the brake lever for reducing the fluid pressure on the upstream side of the hydraulic unit.

10. The braking system of claim 1, wherein the drive unit is an electromagnetic driver.

11. The braking system of claim 2, wherein the alarm unit is selected from the group consisting of light indicating device, sound broadcasting device, vibration device, image displaying device, and combination of aforesaid two or more devices.

12. The braking system of claim 5, wherein the non-return ball valve further comprises:
a ball; and
a spring connected to the ball;
wherein when the fluid pressure at the first gate is lower than the fluid pressure at the second gate, a braking fluid in the brake caliper flows back to the brake lever through the oil chamber in the piston travel channel and the non-return ball valve.

13. The braking system of claim 3, wherein the hydraulic unit further comprises:
a fluid pressure sensing channel, communicating with the oil inlet by one end thereof; and
a fluid pressure sensor, being connected to the other end of the fluid pressure sensing channel, and used for monitoring the fluid pressure at the oil inlet;
wherein the fluid pressure sensor is also electrically connected to the ECU, such that the ECU is able to control the drive unit to make the piston execute the piston travel according to a fluid pressure signal generated by the fluid pressure sensor.

14. The braking system of claim 6, wherein the drive unit further comprises:
a stop pin, being connected to the connect rod for applying a motion limitation to the piston;
a return spring, being connected to the stop pin;
wherein the motion limitation on the piston can be released by making the stop pin move with the connect rod driven by the magnetic field of the coil.

15. The braking system of claim 2, further comprising:
a wheel speed sensor, being used for capturing wheel information of the vehicle and outputting a wheel speed signal to the ECU.

16. The braking system of claim 1, wherein the suspension travel sensor comprises:
a rheostat; and
an adjust unit, being connected to the rheostat, and configured to adjust the resistance of the rheostat according to the suspension displacement;
wherein the rheostat is a sliding rheostat or a rotary rheostat, and the adjust unit being selected from the group consisting of linage mechanism, drag link mechanism, push rod mechanism, slider mechanism, and combination of aforesaid two or more mechanisms.
